(19) United States
(12) Patent Application Publication
(10) Pub. No.: US 2024/0221253 A1
(43) Pub. Date: Jul. 4, 2024

(54) PICTURE EDITING METHOD, ELECTRONIC DEVICE, AND STORAGE MEDIUM

(71) Applicant: BEIJING DAJIA INTERNET INFORMATION TECHNOLOGY CO., LTD., Beijing (CN)

(72) Inventors: Zihui YE, Beijing (CN); Zhao LI, Beijing (CN)

(21) Appl. No.: 18/240,745

(22) Filed: Aug. 31, 2023

(30) Foreign Application Priority Data
Jan. 4, 2023 (CN) 202310006904.4

(51) Int. Cl. G06T 11/60; G06F 3/0482; G06F 3/04845

(52) U.S. Cl. CPC G06T 11/60; G06F 3/0482; G06F 3/04845

(57) ABSTRACT

A picture editing method includes: in response to a picture effect adding operation for at least two to-be-edited pictures, displaying thumbnails corresponding to each of the at least two to-be-edited pictures in a picture editing page, and displaying at least one picture effect template; in response to a selection operation for each of the thumbnails, obtaining a first to-be-edited picture corresponding to a first thumbnail selected by the selection operation; and in response to an operation of applying a target picture effect template in the at least one picture effect template to the first to-be-edited picture, adding a target picture effect corresponding to the target picture effect template to the first to-be-edited picture, and displaying the first to-be-edited picture added with the target picture effect in the picture editing page.

### CROSS-REFERENCE TO RELATED APPLICATIONS

This application is based upon and claims priority to Chinese Patent Application No. 202310006904.4, filed Jan. 4, 2023, the entire contents of which are incorporated herein by reference.

### FIELD

The present disclosure relates to the technical field of picture processing, and more particularly to a picture editing method and device, an electronic device, and a storage medium.

### BACKGROUND

With the development of the picture processing technology, a technology for editing a picture by using an effect template has emerged. In this technology, a plurality of effect templates for editing pictures are displayed in a picture editing page, and a user may select one of the effect templates and apply it to a to-be-edited picture to obtain a picture with a picture effect corresponding to the selected effect template.

In the related art, only one picture can be added with an effect in a once effect adding operation in the picture editing page, so that if a user wants to add effects to a plurality of pictures, the user has to exit the picture editing page after a certain picture is added with the effect, and reselect a new picture and re-enter the picture editing page again to add an effect to the reselected picture.

It can be seen that the existing manner of adding an effect template to a plurality of pictures needs to repeatedly exit and enter the picture editing page, which results in tedious user operation and low picture editing efficiency.

### SUMMARY

According to a first aspect of embodiments of the present disclosure, a picture editing method is provided, which includes: in response to a picture effect adding operation for at least two to-be-edited pictures, displaying thumbnails corresponding to each of the at least two to-be-edited pictures in a picture editing page, and displaying at least one picture effect template: in response to a selection operation for each of the thumbnails, obtaining a first to-be-edited picture corresponding to a first thumbnail selected by the selection operation: and in response to an operation of applying a target picture effect template in the at least one picture effect template to the first to-be-edited picture, adding a target picture effect corresponding to the target picture effect template to the first to-be-edited picture, and displaying the first to-be-edited picture added with the target picture effect in the picture editing page.

According to a second aspect of embodiments of the present disclosure, an electronic device is provided, which includes: a processor: and a memory configured to store a processor-executable instruction. The processor is configured to execute the instruction to implement the picture editing method as described in any one of embodiments in the first aspect.

According to a third aspect of embodiments of the present disclosure, a computer-readable storage medium is provided. The computer-readable storage medium has stored therein an instruction that, when executed by a processor of an electronic device, causes the electronic device to perform the picture editing method as described in any one of embodiments in the first aspect.

It is to be understood that both the foregoing general description and the following detailed description are illustrative and explanatory and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure, and do not constitute an improper limitation on the present disclosure.

FIG. 1 is a schematic flowchart showing a picture editing method according to an illustrative embodiment.

FIG. 2 is a schematic diagram showing an interface of a picture editing page according to an illustrative embodiment.

FIG. 3 is a schematic diagram showing an interface of a picture editing page according to an illustrative embodiment.

FIG. 4 is a schematic flowchart of switching a to-be-edited picture according to an illustrative embodiment.

FIG. 5 is a schematic diagram showing an interface of a picture editing page according to an illustrative embodiment.

FIG. 6 is a schematic diagram showing an interface of a picture editing page according to an illustrative embodiment.

FIG. 7 is a schematic diagram showing an interface of a picture editing page according to an illustrative embodiment.

FIG. 8 is a schematic diagram showing an interface of a picture editing page according to an illustrative embodiment.

FIG. 9 is a schematic flowchart of displaying each of to-be-edited pictures added with a picture effect according to an illustrative embodiment.

FIG. 10 is a schematic diagram showing an interface of a picture editing page according to an illustrative embodiment.

FIG. 11 is a schematic diagram showing an interface of a picture editing page according to an illustrative embodiment.

FIG. 12 is a schematic block diagram showing a picture editing device according to an illustrative embodiment.

FIG. 13 is a schematic block diagram showing an electronic device according to an illustrative embodiment.

### DETAILED DESCRIPTION

In order to enable those skilled in the art to better understand the present disclosure, embodiments of the present disclosure will be described clearly and completely below with reference to the accompanying drawings.

It should be noted that the terms “first”, “second” and the like in the specification, claims and the accompanying drawings of the present disclosure are used to distinguish similar objects, and are not intended to describe a specific sequence or order. It should be understood that features defined with “first”, “second” and the like may be interchanged in appropriate circumstances, so that embodiments of the present disclosure described herein can be implemented in a sequence other than those illustrated or described herein. The implementations set forth in the following description of illustrative embodiments do not represent all implementations consistent with the present disclosure. Instead, they are merely examples of devices and methods consistent with some aspects of the present disclosure as recited in the appended claims.

It should also be noted that user information (including, but not limited to, user equipment information, user personal information, etc.) and data (including, but not limited to, data for presentation or analysis, etc.) involved in the present disclosure are information and data authorized by users or fully authorized by each party.

Embodiments of the present disclosure provide a picture editing method and device, an electronic device, and a storage medium, to at least solve the problem of low picture editing efficiency in the related art.

In some embodiments of the present disclosure, a picture editing method is provided, which includes: in response to a picture effect adding operation for at least two to-be-edited pictures, displaying thumbnails corresponding to each of the at least two to-be-edited pictures in a picture editing page, and displaying at least one picture effect template: in response to a selection operation for each of the thumbnails, obtaining a first to-be-edited picture corresponding to a first thumbnail selected by the selection operation: and in response to an operation of applying a target picture effect template in the at least one picture effect template to the first to-be-edited picture, adding a target picture effect corresponding to the target picture effect template to the first to-be-edited picture, and displaying the first to-be-edited picture added with the target picture effect in the picture editing page.

In an illustrative embodiment, in response to the picture effect adding operation for at least two to-be-edited pictures, displaying the thumbnails corresponding to each of the at least two to-be-edited pictures in the picture editing page, and displaying the at least one picture effect template include: in response to the picture effect adding operation, displaying an effect template adding area in the picture editing page: in which the effect template adding area includes an effect template display area and a thumbnail display area: and displaying the at least one picture effect template in the effect template display area, and displaying each of the thumbnails in the thumbnail display area. In response to the operation of applying the target picture effect template in the at least one picture effect template to the first to-be-edited picture, adding the target picture effect corresponding to the target picture effect template to the first to-be-edited picture, and displaying the first to-be-edited picture added with the target picture effect in the picture editing page include: in response to a picture effect template selection operation triggered in the effect template display area, taking a selected picture effect template as the target picture effect template: and adding the target picture effect corresponding to the target picture effect template to the first to-be-edited picture, and displaying the first to-be-edited picture added with the target picture effect in the picture editing page.

In an illustrative embodiment, the picture editing page carries a picture preview area: after obtaining the first to-be-edited picture corresponding to the first thumbnail selected by the selection operation, the method further includes: displaying the first to-be-edited picture in the picture preview area, and setting a selection state of the first thumbnail to a selected state in the thumbnail display area: and displaying the first to-be-edited picture added with the target picture effect in the picture editing page includes: displaying the first to-be-edited picture added with the target picture effect in the picture preview area.

In an illustrative embodiment, after setting the selection state of the first thumbnail corresponding to the first to-be-edited picture to the selected state, the method further includes: in response to a thumbnail switching operation triggered in the thumbnail display area, obtaining a second thumbnail switched to; and displaying a second to-be-edited picture corresponding to the second thumbnail in the picture preview area, canceling the selected state of the first thumbnail in the thumbnail display area, and setting a selection state of the second thumbnail to a selected state.

In an illustrative embodiment, the picture editing page carries an effect template display control: and in response to the picture effect adding operation, displaying the effect template adding area in the picture editing page includes: in response to a trigger operation for the effect template display control, displaying the effect template adding area in the picture editing page.

In an illustrative embodiment, the thumbnail display area carries an effect template application control: and after taking the selected picture effect template as the target picture effect template, the method further includes: in response to a trigger operation for the effect template application control, adding a target picture effect corresponding to the target picture effect template to each of the at least two to-be-edited pictures, and displaying each of the at least two to-be-edited pictures added with the target picture effect in the picture editing page.

In an illustrative embodiment, the effect template adding area carries a picture saving control: and displaying each of the at least two to-be-edited pictures added with the target picture effect in the picture editing page includes: in response to a trigger operation for the picture saving control, saving each of the at least two to-be-edited pictures added with the target picture effect, and displaying each of the at least two to-be-edited pictures added with the target picture effect in the picture preview area carried by the picture editing page.

In an illustrative embodiment, the picture editing page carries a plurality of display mode identifiers representing different picture display modes: and displaying each of the at least two to-be-edited pictures added with the target picture effect in the picture editing page includes: obtaining a target display mode identifier currently selected: and displaying each of the at least two to-be-edited pictures added with the target picture effect in the picture editing page according to a picture display mode represented by the target display mode identifier.

In an illustrative embodiment, displaying each of the at least two to-be-edited pictures added with the target picture effect in the picture editing page according to the picture display mode represented by the target display mode identifier includes: in case that the target display mode identifier is a first display mode identifier, generating a picture set according to each of the at least two to-be-edited pictures added with the target picture effect: and displaying pictures contained in the picture set in the picture editing page.

In an illustrative embodiment, displaying each of the at least two to-be-edited pictures added with the target picture effect in the picture editing page according to the picture display mode represented by the target display mode identifier includes: in case that the target display mode identifier is a second display mode identifier, performing picture splicing processing on each of the at least two to-be-edited pictures added with the target picture effect to obtain a spliced picture: and displaying the spliced picture in the picture editing page.

In an illustrative embodiment, after displaying each of the at least two to-be-edited pictures added with the target picture effect in the picture editing page according to the picture display mode represented by the target display mode identifier, the method further includes: in response to an identifier switching operation for the display mode identifiers, obtaining a display mode identifier switched to: and displaying each of the at least two to-be-edited pictures added with the target picture effect in the picture editing page according to a picture display mode represented by the display mode identifier.

In some embodiments of the present disclosure, a picture editing device is provided, which includes: an editing page display unit, a picture obtaining unit, and a picture effect adding unit. The editing page display unit is configured to: display thumbnails corresponding to each of at least two to-be-edited pictures in a picture editing page, and display at least one picture effect template, in response to a picture effect adding operation for the at least two to-be-edited pictures. The picture obtaining unit is configured to, in response to a selection operation for each of the thumbnails, obtain a first to-be-edited picture corresponding to a first thumbnail selected by the selection operation. The picture effect adding unit is configured to, in response to an operation of applying a target picture effect template in the at least one picture effect template to the first to-be-edited picture, add a target picture effect corresponding to the target picture effect template to the first to-be-edited picture, and display the first to-be-edited picture added with the target picture effect in the picture editing page.

In an illustrative embodiment, the editing page display unit is further configured to: display an effect template adding area in the picture editing page in response to the picture effect adding operation: in which the effect template adding area includes an effect template display area and a thumbnail display area: and display the at least one picture effect template in the effect template display area, and display each of the thumbnails in the thumbnail display area. The picture effect adding unit is further configured to: take a selected picture effect template as the target picture effect template in response to a picture effect template selection operation triggered in the effect template display area: and add the target picture effect corresponding to the target picture effect template to the first to-be-edited picture, and display the first to-be-edited picture added with the target picture effect in the picture editing page.

In an illustrative embodiment, the picture editing page carries a picture preview area. The picture obtaining unit is further configured to: display the first to-be-edited picture in the picture preview area, and set a selection state of the first thumbnail to a selected state in the thumbnail display area. The picture effect adding unit is further configured to display the first to-be-edited picture added with the target picture effect in the picture preview area.

In an illustrative embodiment, the picture editing device further includes: a picture switching unit. The picture switching unit is configured to: obtain a second thumbnail switched to in response to a thumbnail switching operation triggered in the thumbnail display area: and display a second to-be-edited picture corresponding to the second thumbnail in the picture preview area, cancel the selected state of the first thumbnail in the thumbnail display area, and set a selection state of the second thumbnail to a selected state.

In an illustrative embodiment, the picture editing page carries an effect template display control. The editing page display unit is further configured to display the effect template adding area in the picture editing page in response to a trigger operation for the effect template display control.

In an illustrative embodiment, the thumbnail display area carries an effect template application control. The picture effect adding unit is further configured to: add a target picture effect corresponding to the target picture effect template to each of the at least two to-be-edited pictures, and display each of the at least two to-be-edited pictures added with the target picture effect in the picture editing page, in response to a trigger operation for the effect template application control.

In an illustrative embodiment, the effect template adding area carries a picture saving control. The picture editing device is further includes: a picture storage unit. The picture storage unit is configured to: save each of the at least two to-be-edited pictures added with the target picture effect, and display each of the at least two to-be-edited pictures added with the target picture effect in the picture preview area carried by the picture editing page, in response to a trigger operation for the picture saving control.

In an illustrative embodiment, the picture editing page carries a plurality of display mode identifiers representing different picture display modes. The picture effect adding unit is further configured to: obtain a target display mode identifier currently selected: and display each of the at least two to-be-edited pictures added with the target picture effect in the picture editing page according to a picture display mode represented by the target display mode identifier.

In an illustrative embodiment, the picture effect adding unit is further configured to: generate a picture set according to each of the at least two to-be-edited pictures added with the target picture effect: and display pictures contained in the picture set in the picture editing page, in case that the target display mode identifier is a first display mode identifier.

In an illustrative embodiment, the picture effect adding unit is further configured to: perform picture splicing processing on each of the at least two to-be-edited pictures added with the target picture effect to obtain a spliced picture: and display the spliced picture in the picture editing page, in case that the target display mode identifier is a second display mode identifier.

In an illustrative embodiment, the picture effect adding unit is further configured to: obtain a display mode identifier switched to in response to an identifier switching operation for the display mode identifiers: and display each of the at least two to-be-edited pictures added with the target picture effect in the picture editing page according to a picture display mode represented by the display mode identifier.

In some embodiments of the present disclosure, an electronic device is provided, which includes: a processor: and a memory configured to store a processor-executable instruction. The processor is configured to execute the instruction to implement the picture editing method as described in any one of embodiments in the first aspect.

In some embodiments of the present disclosure, a computer-readable storage medium is provided. The computer-readable storage medium has stored therein an instruction that, when executed by a processor of an electronic device, causes the electronic device to perform the picture editing method as described in any one of embodiments in the first aspect.

In some embodiments of the present disclosure, a computer program product is provided, which includes an instruction that, when executed by a processor of an electronic device, causes the electronic device to perform the picture editing method as described in any one of embodiments in the first aspect.

According to embodiments of the present disclosure, in response to the picture effect adding operation for at least two to-be-edited pictures, thumbnails corresponding to each of the at least two to-be-edited pictures are displayed in the picture editing page, and at least one picture effect template is displayed: in response to the selection operation for each of the thumbnails, the first to-be-edited picture corresponding to the first thumbnail selected by the selection operation is obtained: and in response to the operation of applying the target picture effect template in the at least one picture effect template to the first to-be-edited picture, the target picture effect corresponding to the target picture effect template is added to the first to-be-edited picture, and the first to-be-edited picture added with the target picture effect is displayed in the picture editing page. With embodiments of the present disclosure, a terminal responds to the picture effect adding operation triggered by a user for a plurality of to-be-edited pictures, displays the thumbnails corresponding to each of the plurality of to-be-edited pictures in the displayed picture editing page, and displays at least one picture effect template, so that the user can make a selection on the displayed thumbnails, and the terminal obtains 20) the first to-be-edited picture corresponding to the selected first thumbnail, and add the picture effect to the first to-be-edited picture and display the first to-be-edited picture added with the picture effect. Compared with the related art that needs to repeatedly exit and enter the picture editing page to implement the effect editing for a plurality of pictures, embodiments of the present disclosure enable the thumbnails of the plurality of to-be-edited pictures to be displayed in the picture editing page and allow the selection on the thumbnails, so as to realize the editing on the plurality of to-be-edited pictures in the same picture editing page, without repeatedly exiting and entering the picture editing page, thereby reducing the user operation and improving the picture editing efficiency.

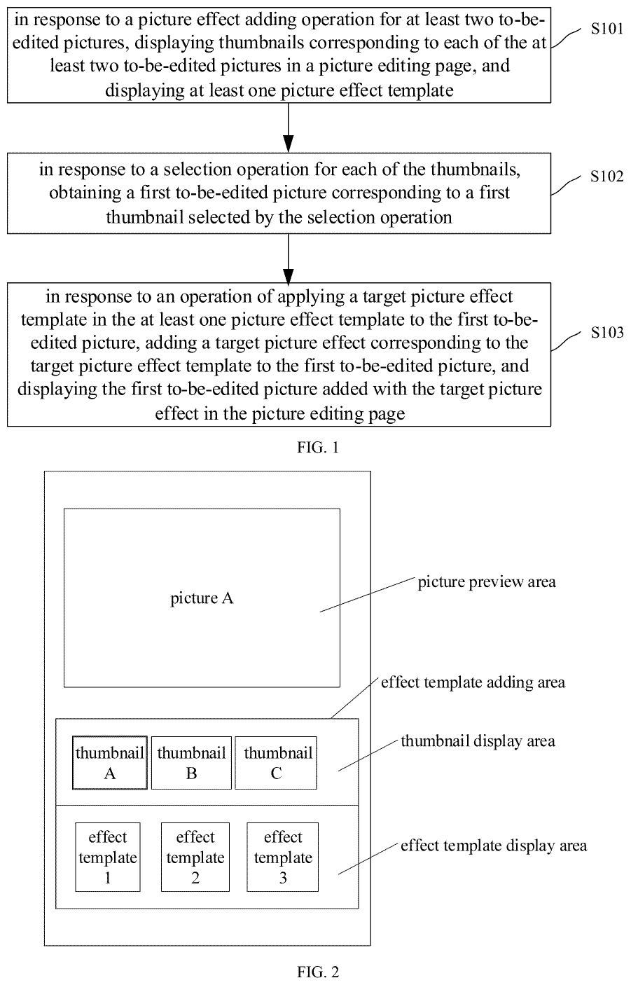

FIG. 1 is a schematic flowchart showing a picture editing method according to an illustrative embodiment, as shown in FIG. 1, the picture editing method is used in a terminal and includes steps as follows.

In step S101, in response to a picture effect adding operation for at least two to-be-edited pictures, thumbnails corresponding to each of the at least two to-be-edited pictures are displayed in a picture editing page, and at least one picture effect template is displayed.

The picture effect adding operation refers to an operation triggered by a user for adding a picture effect to a picture, and the picture effect adding operation may be triggered by the user on the picture editing page. The to-be-edited picture refers to a picture needing to be added with a picture effect, and the to-be-edited picture may be selected by the user from pictures stored in a picture folder of a terminal in advance. In embodiments of the present disclosure, at least two pictures need to be edited, that is, the user may select a plurality of pictures from the picture folder as the to-be-edited pictures needing to be added with the picture effect. The picture editing page is a page for implementing picture editing, and the thumbnail corresponding to each to-be-edited picture selected by the user may be displayed in the picture editing page. Further, the picture effect template for adding the picture effect may also be displayed in the picture editing page, and a plurality of picture effect templates may be provided for representing different types of picture effects, respectively.

Specifically, the user may select at least two pictures from the picture folder of the terminal as the to-be-edited pictures that need to be added with the picture effect, and enter the picture editing page to implement picture editing processing for the above to-be-edited pictures. In addition, the user, via the terminal, may also trigger the picture effect adding operation for adding the picture effect to the above to-be-edited pictures. At the moment, the terminal may respond to the picture effect adding operation, and display the thumbnails of each of the at least two to-be-edited pictures and a preset picture effect template for adding the picture effect in the picture editing page.

In step S102, in response to a selection operation for each of the thumbnails, a first to-be-edited picture corresponding to a first thumbnail selected by the selection operation is obtained.

The first thumbnail refers to a thumbnail selected by the user from a plurality of thumbnails in the picture editing page via the selection operation, and the first to-be-edited picture refers to a to-be-edited picture corresponding to the first thumbnail. After the terminal displays the respective thumbnails of the at least two to-be-edited pictures through the picture editing page, the user may perform a selection operation on any one of the plurality of thumbnails, and the terminal may respond to the selection operation to obtain a thumbnail selected by the selection operation of the user as the first thumbnail, and determine the to-be-edited picture corresponding to the first thumbnail as the first to-be-edited picture.

For example, the to-be-edited pictures may include a picture A, a picture B and a picture C. The picture A corresponds to a thumbnail A, the picture B corresponds to a thumbnail B, and the picture C corresponds to a thumbnail C. The terminal may display the thumbnail A, the thumbnail B and the thumbnail C in the picture editing page. The user may perform the selection operation for the thumbnails displayed in the picture editing page. For example, the user may trigger the above selection operation by clicking on the thumbnail B. The terminal may respond to the selection operation to determine the thumbnail B as the first thumbnail, and determine the picture B corresponding to the thumbnail B as the first to-be-edited picture.

In step S103, in response to an operation of applying a target picture effect template in the at least one picture effect template to the first to-be-edited picture, a target picture effect corresponding to the target picture effect template is added to the first to-be-edited picture, and the first to-be-edited picture added with the target picture effect is displayed in the picture editing page.

The target picture effect template refers to a picture effect template to be applied to the first to-be-edited picture, and the target picture effect refers to a picture effect represented by the target picture effect template. As different picture effect templates represent different picture effects, respectively, the user may determine the target picture effect template from the above at least one picture effect template, and trigger to the terminal the operation of applying the target picture effect template to the first to-be-edited picture, and at the moment, the terminal responds to this operation, so that the target picture effect corresponding to the target picture effect template is added to the first to-be-edited picture obtained in the step S102, and the first to-be-edited picture added with the target picture effect may also be displayed in the picture editing page.

For example, the at least one picture effect template may include an effect template 1, an effect template 2 and an effect template 3 corresponding to a picture effect 1, a picture effect 2 and a picture effect 3, respectively: After the terminal obtains the picture B as the first to-be-edited picture, the user may trigger an operation of applying the effect template 3 in the above at least one picture effect template to the picture B, and at this moment, the terminal may respond to the operation to use the effect template 3 as the target picture effect template, apply the picture effect 3 corresponding to the effect template 3 to the picture B to obtain the first to-be-edited picture added with the target picture effect, i.e., a picture B3, and display the picture B3 in the picture editing page.

In the above picture editing method, in response to the picture effect adding operation for at least two to-be-edited pictures, thumbnails corresponding to each of the at least two to-be-edited pictures are displayed in the picture editing page, and at least one picture effect template is displayed; in response to the selection operation for each of the thumbnails, the first to-be-edited picture corresponding to the first thumbnail selected by the selection operation is obtained: and in response to the operation of applying the target picture effect template in the at least one picture effect template to the first to-be-edited picture, the target picture effect corresponding to the target picture effect template is added to the first to-be-edited picture, and the first to-be-edited picture added with the target picture effect is displayed in the picture editing page. With embodiments of the present disclosure, the terminal responds to the picture effect adding operation triggered by the user for a plurality of to-be-edited pictures, displays the thumbnails corresponding to each of the plurality of to-be-edited pictures in the displayed picture editing page, and displays at least one picture effect template, so that the user can make a selection on the displayed thumbnails, and the terminal obtains the first to-be-edited picture corresponding to the selected first thumbnail, and add the picture effect to the first to-be-edited picture and display the first to-be-edited picture added with the picture effect. Compared with the related art that needs to repeatedly exit and enter the picture editing page to implement the effect editing for a plurality of pictures, embodiments of the present disclosure enable the thumbnails of the plurality of to-be-edited pictures to be displayed in the picture editing page and allow the selection on the thumbnails, so as to realize the editing on the plurality of to-be-edited pictures in the same picture editing page, without repeatedly exiting and entering the picture editing page, thereby reducing the user operation and improving the picture editing efficiency.

In an illustrative embodiment, the step S101 may further include: in response to the picture effect adding operation, displaying in the picture editing page an effect template adding area which includes an effect template display area and a thumbnail display area: and displaying the at least one picture effect template in the effect template display area and displaying each of the thumbnails in the thumbnail display area. The step S103 may further include: in response to a picture effect template selection operation triggered in the effect template display area, taking a selected picture effect template as the target picture effect template: and adding a target picture effect corresponding to the target picture effect template to the first to-be-edited picture, and displaying the first to-be-edited picture added with the target picture effect in the picture editing page.

The effect template adding area is an area displayed in the picture editing page and used for adding the picture effect, and the area may be composed of two parts, i.e., the effect template display area and the thumbnail display area. The effect template display area is an area used for displaying each of the preset at least one picture effect template, and the thumbnail display area is an area used for displaying the thumbnails corresponding to each of the at least two to-be-edited pictures. Specifically, after the user triggers the picture effect adding operation, the terminal may respond to the operation and display the effect template adding area carrying the effect template display area and the thumbnail display area in the displayed picture editing page. Meanwhile, the terminal may also display each of the picture effect templates corresponding to preset different picture effects respectively in the effect template display area, and display the thumbnails corresponding to each of the at least two to-be-edited pictures in the thumbnail display area.

After the terminal displays the at least one picture effect template in the effect template display area, the user may trigger a selection operation aiming at a certain picture effect template in the effect template display area. For example, the user may trigger the picture effect template selection operation by clicking on the certain picture effect template in the effect template display area. The terminal may respond to the selection operation, determine the picture effect template selected by the user as the target picture effect template, add the target picture effect corresponding to the target picture effect template to the first to-be-edited picture, and display the first to-be-edited picture added with the target picture effect template in the picture editing page.

For example, the effect template display area may carry the effect template 1, the effect template 2 and the effect template 3. After the user selects the effect template 3 by clicking on the effect template 3, the terminal may take the effect template 3 as the target picture effect template, take the picture effect 3 corresponding to the effect template 3 as the target picture effect, add the picture effect 3 to the first to-be-edited picture, and display the first to-be-edited picture added with the picture effect 3 in the picture editing page.

In this embodiment, after the user triggers the picture effect adding operation, the effect template adding area carrying the effect template display area and the thumbnail display area may be displayed in the picture editing page, and the terminal may display the at least one picture effect template in the effect template display area and display the thumbnail of each of the at least two to-be-edited pictures in the thumbnail display area. The user only needs to select the picture effect template in the effect template display area, the target picture effect corresponding to the selected target picture effect template can be added to the first to-be-edited picture, so that the efficiency of adding the picture effect to the first to-be-edited picture is further improved.

Further, the picture editing page further carries a picture preview area. After the step S102, the method may further include: displaying the first to-be-edited picture in the picture preview area, and setting a selection state of the first thumbnail to a selected state in the thumbnail display area. The step S103 may further include: displaying the first to-be-edited picture added with the target picture effect in the picture preview area.

The picture preview area is an area used for previewing the to-be-edited picture in the picture editing page. In this embodiment, the picture editing page may further carry the picture preview area used for previewing the editing effect of the to-be-edited picture. After the terminal determines the first to-be-edited picture selected by the user, the terminal can further display the first to-be-edited picture in the picture preview area of the picture editing page. Meanwhile, in the thumbnail display area, the selection state of the first thumbnail may be set to the selected state, and the selected state may be represented by displaying a selected identifier in the first thumbnail, or by setting a different display form from other thumbnails. For example, the frame of the first thumbnail may be bold or may be display with a different color from other thumbnails to represent that the first thumbnail is selected.

Subsequently; after the target picture effect corresponding to the target picture effect template is added to the first to-be-edited picture, the first to-be-edited picture added with the target picture effect may also be displayed in the picture preview area carried by the picture editing page for the user to preview an adding effect of the target picture effect.

For example, after the user triggers the picture effect adding operation, the picture editing page displayed by the terminal may include the picture preview area and the effect template adding area, and the effect template adding area includes the effect template display area and the thumbnail display area. The effect template display area carries the effect template 1, the effect template 2 and the effect template 3, representing the picture effect 1, the picture effect 2 and the picture effect 3, respectively. The thumbnail display area may carry the thumbnail A, the thumbnail B and the thumbnail C, corresponding to the picture A, the picture B and the picture C to be edited, respectively. After the user selects the thumbnail A in the thumbnail display area, the terminal may take the thumbnail A as the first thumbnail, display the picture A corresponding to the thumbnail A in the picture preview area, and set the frame of the thumbnail A to be bold to represent that the thumbnail A has been selected as the first thumbnail, as shown in FIG. 2.

Then, on the basis of the picture editing page shown in FIG. 2, the user may also trigger a selection operation for the target picture effect template in the effect template display area. For example, the user may click on the effect template 2 to select the effect template 2 as the target picture effect template, and at this moment, the frame of the effect template 2 may become to be bold in the effect template display area to represent that the effect template 2 has been selected as the target picture effect template. At the same time, the terminal may add a picture effect (i.e. the picture effect 2) corresponding to the effect template 2 to the picture A as the first to-be-edited picture, and update the originally displayed picture A to the picture A added with the picture effect 2 in the picture preview area, that is, update the picture preview area to display the picture A added with the picture effect 2, i.e., a picture A2, as shown in FIG. 3.

In this embodiment, the terminal may display the first to-be-edited picture in the picture preview area, and after the first to-be-edited picture is added with the target picture effect, the terminal may further display the first to-be-edited picture added with the target picture effect in the picture preview area, so as to preview the first to-be-edited picture added with the target picture effect. Moreover, after the first thumbnail is selected, the selection state of the first thumbnail may be set to the selected state to inform the user of a currently selected thumbnail, so that the intelligence of displaying the picture editing page is further improved.

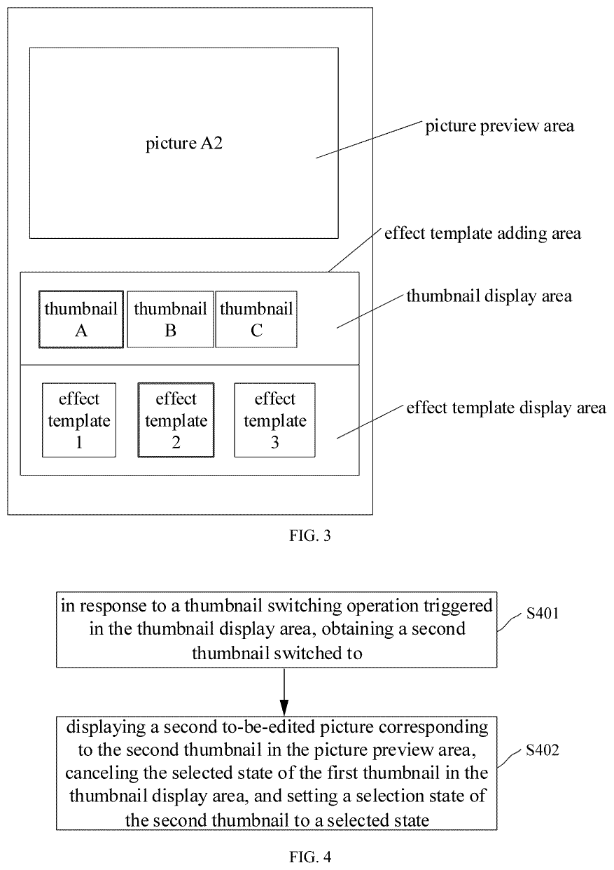

In addition, as shown in FIG. 4, after setting the selection state of the first thumbnail corresponding to the first to-be-edited picture to the selected state, the method further includes steps S401 and S402.

In the step S401, in response to a thumbnail switching operation triggered in the thumbnail display area, a second thumbnail switched to is obtained.

The thumbnail switching operation is an operation used for switching a selected thumbnail. In this embodiment, when the user needs to switch a current to-be-edited picture for picture effect adding, the thumbnail switching operation may be triggered by directly clicking on other thumbnails displayed in the thumbnail display area. At the moment, the terminal may obtain a thumbnail witched to after the thumbnail switching operation as the second thumbnail.

In the step S402, a second to-be-edited picture corresponding to the second thumbnail is displayed in the picture preview area, the selected state of the first thumbnail is canceled in the thumbnail display area, and a selection state of the second thumbnail is set to a selected state.

The second to-be-edited picture refers to a to-be-edited picture corresponding to the second thumbnail. After the user performs the thumbnail switching operation, the terminal may switch the displayed first to-be-edited picture to the second to-be-edited picture in the picture preview area. At the same time, the selected state of the first thumbnail in the thumbnail display area may be canceled, and the selection state of the second thumbnail is set to the selected state.

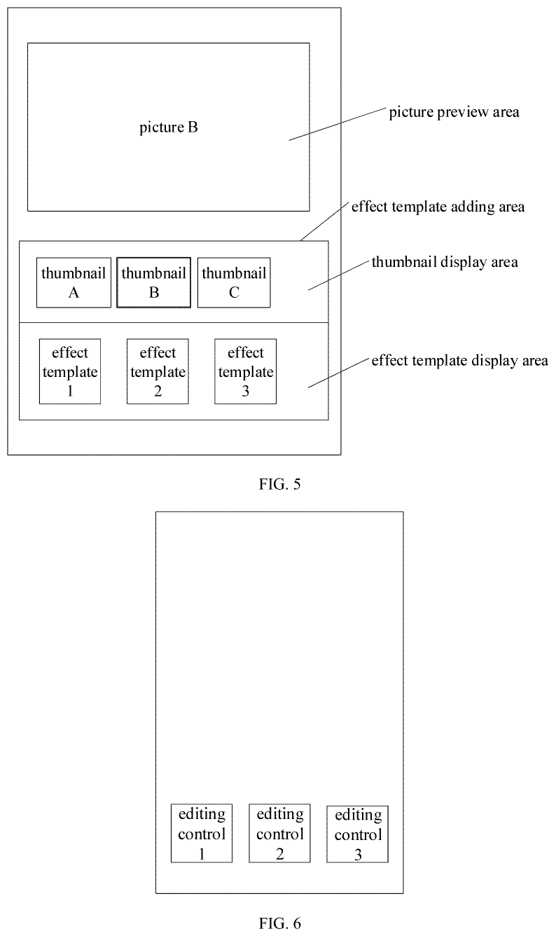

For example, on the basis of the picture editing page shown in FIG. 2, the user may trigger the thumbnail switching operation to the terminal by clicking on the thumbnail B in the thumbnail display area. At this moment, the terminal may take the thumbnail B as the second thumbnail after executing the switching operation, and switch the picture A displayed as the first to-be-edited picture to the picture B as the second to-be-edited picture in the picture preview area. At the same time, the bold state of the frame of the thumbnail A in the thumbnail display area may be canceled to represent the cancellation of the selected state of the first thumbnail, and the frame of the thumbnail B may be set to bold to represent that the selection state of the second thumbnail is set to the selected state, as shown in FIG. 5.

In this embodiment, the user may trigger the thumbnail switching operation in the thumbnail display area to implement the switching of the to-be-edited picture, without needing to exit the current picture editing page, so that the switching efficiency of the to-be-edited picture may be further improved.

In an illustrative embodiment, the picture editing page carries an effect template display control. In response to the picture effect adding operation, displaying the effect template adding area in the picture editing page may further includes: in response to a trigger operation for the effect template display control, displaying the effect template adding area in the picture editing page.

The effect template display control is a control used for displaying the effect template in the picture editing page. In this embodiment, the picture editing page may implement different types of editing processing for the to-be-edited picture, for example, adding text to the to-be-edited picture, adding background music to the to-be-edited picture, or adding a picture effect to the to-be-edited picture, etc. The effect template display control is a function control used for adding the picture effect to the to-be-edited picture.

Specifically; as shown in FIG. 6, after the user selects a plurality of to-be-edited pictures and enters the picture editing page, the picture editing page may carry an editing control 1, an editing control 2 and an editing control 3. The editing control 1 is configured for providing a function of adding a picture effect to the to-be-edited pictures, that is, the editing control 1 is an effect template display control. The editing control 2 is configured for providing a function of adding background music to the to-be-edited pictures, and the editing control 3 is configured for providing a function of adding text to the to-be-edited pictures. When the user clicks on the editing control 1, the trigger operation for the effect template display control may be triggered, and at the moment, the terminal may respond to the operation, and display the effect template adding area in the picture editing page.

In this embodiment, the function control for adding the picture effect to the to-be-edited pictures, i.e., the effect template display control, is added in the picture editing page, so that when the user triggers the effect template display control, the effect template adding area may be displayed in the picture editing page. In this way, the efficiency of adding the picture effect may be improved on the picture editing page integrating a plurality of picture editing functions.

In an illustrative embodiment, the thumbnail display area carries an effect template application control. After taking the selected picture effect template as the target picture effect template, the method further includes: in response to a trigger operation for the effect template application control, adding a target picture effect corresponding to the target picture effect template to each of the at least two to-be-edited pictures, and displaying each of the at least two to-be-edited pictures added with the target picture effect in the picture editing page.

The effect template application control is a control used for applying a certain effect template to all the to-be-edited pictures. In this embodiment, the thumbnail display area is further provided with the effect template application control for adding the target picture effect corresponding to the target picture effect template to all the to-be-edited pictures. After the user selects the target picture effect template, the terminal may add the target picture effect corresponding to the target picture effect template to the first to-be-edited picture corresponding to the first thumbnail currently selected by the user, while for the remaining to-be-edited pictures, the picture effect is not added yet. If the user needs to add the target picture effect to all the to-be-edited pictures, the user may trigger the effect template application control carried in the thumbnail display area, and at this moment, the terminal may respond to the trigger operation to add the target picture effect corresponding to the target picture effect template to all the to-be-edited pictures, and display each of the to-be-edited picture added with the target picture effect in the picture editing page.

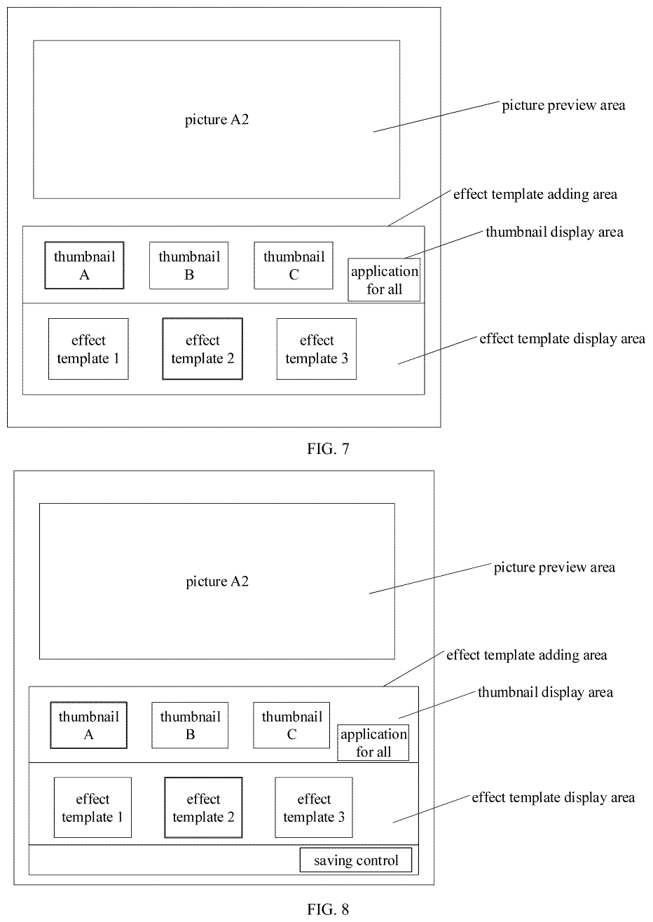

For example, as shown in FIG. 7, the thumbnail display area carries the effect template application control, i.e., an “application for all” control. For example, after the user selects the effect template 2 as the target picture effect template, and the corresponding picture effect 2 is added to the picture A as the first to-be-edited picture, the user may click on the “application for all” control in the thumbnail display area to further add the picture effect 2 to all the to-be-edited pictures, that is, the picture effect 2 is added to each of the picture B and the picture C, so that the current picture effect is added to all the to-be-edited pictures by one click.

In this embodiment, the thumbnail display area may further provide the effect template application control, and the user may perform the trigger operation for the effect template application control, so that the current picture effect is added to all the to-be-edited pictures by one click, thereby improving the efficiency of adding the picture effect to a plurality of to-be-edited pictures while ensuring the effect consistency of the plurality of to-be-edited pictures.

In an illustrative embodiment, the effect template adding area carries a picture saving control. Displaying each of the at least two to-be-edited pictures added with the target picture effect in the picture editing page includes: in response to a trigger operation for the picture saving control, saving each of the at least two to-be-edited pictures added with the target picture effect, and displaying each of the at least two to-be-edited pictures added with the target picture effect in the picture preview area carried by the picture editing page.

The picture saving control is a function control used for saving the to-be-edited pictures added with the picture effect, and the picture saving control may be disposed in the effect template adding area. After the target picture effect is added to all of the at least two to-be-edited pictures, the user may save each of the at least two to-be-edited pictures added with the target picture effect. The user may perform the trigger operation for the picture saving control provided in the effect template adding area to save each of the at least two to-be-edited pictures added with the target picture effect, and after the save processing is completed, each of the at least two to-be-edited pictures added with the target picture effect is displayed in the picture preview area carried by the picture editing page.

For example, as shown in FIG. 8, the effect template adding area may carry a function control, i.e., the saving control, used for saving to-be-edited pictures added with the picture effect. After the target picture effect is added to all of the at least two to-be-edited pictures, the user may click on the saving control to save each of the at least two to-be-edited pictures added with the target picture effect, and after the save processing is completed, each of the at least two to-be-edited pictures added with the target picture effect is displayed in the picture preview area carried by the picture editing page, for example, the displaying of each of the at least two to-be-edited pictures added with the target picture effect may be switched according to a certain time period.

In this embodiment, the user may save each of the at least two to-be-edited pictures added with the target picture effect through the picture saving control provided in the effect template adding area, and each of the at least two to-be-edited pictures added with the target picture effect is previewed in the picture preview area carried by the picture editing page after the save processing, so that the efficiency of saving pictures subjected to the effect editing is further improved.

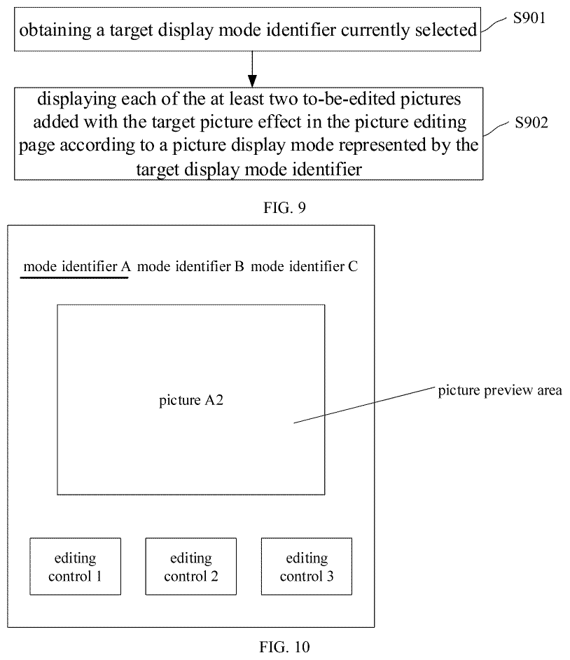

In an illustrative embodiment, the picture editing page carries a plurality of display mode identifiers representing different picture display modes. As shown in FIG. 9, displaying each of the at least two to-be-edited pictures added with the target picture effect in the picture editing page may further includes steps S901 and S902.

In the step S901, a target display mode identifier currently selected is obtained.

In this embodiment, the picture editing page displaying each of the at least two to-be-edited pictures added with the target picture effect may carry the plurality of display mode identifiers for representing different picture display modes. For example, the picture editing page displaying each of the at least two to-be-edited pictures added with the target picture effect may be a picture editing page displayed after the user performs the save processing for the to-be-edited pictures, and at a top of the picture editing page, the plurality of display mode identifiers representing the different picture display modes may be carried. The user may select one of the plurality of display mode identifiers, and the terminal may take the display mode identifier currently selected by the user as the target display mode identifier.

In the step S902, each of the at least two to-be-edited pictures added with the target picture effect is displayed in the picture editing page according to a picture display mode represented by the target display mode identifier.

After the target display mode identifier is determined, the terminal may display each of the at least two to-be-edited pictures added with the target picture effect in the picture editing page according to the picture display mode represented by the target display mode identifier.

In this embodiment, the picture editing page may further carry the plurality of display mode identifiers representing the different picture display modes. When displaying each of the at least two to-be-edited pictures added with the target picture effect, the terminal may obtain the target display mode identifier currently selected by the user, and display each of the at least two to-be-edited pictures added with the target picture effect according to the picture display mode represented by the target display mode identifier. In this way, each of the at least two to-be-edited pictures added with the target picture effect may be displayed through various picture display modes, so that the diversity of the picture display manners may be improved.

Further, the step S902 may further include: in case that the target display mode identifier is a first display mode identifier, generating a picture set according to each of the at least two to-be-edited pictures added with the target picture effect: and displaying pictures contained in the picture set in the picture editing page.

The picture display mode represented by the first display mode identifier is to display each of the at least two to-be-edited pictures added with the target picture effect in a form of the picture set. Specifically, if the display mode identifier currently selected by the user is the first display mode identifier, the terminal may generate a corresponding picture set based on each of the at least two to-be-edited pictures added with the target picture effect, and then display pictures contained in the picture set in the picture editing page.

For example, after the target picture effect is added to each of the at least two to-be-edited pictures, and the at least two to-be-edited pictures added with the target picture effect are saved, the displayed picture editing page may be as shown in FIG. 10. This picture editing page may contain the picture preview area, and the editing control 1, the editing control 2 and the editing control 3 for performing picture editing again on the to-be-edited pictures added with the picture effect. Moreover, the plurality of display mode identifiers, such as a mode identifier A, a mode identifier B and a mode identifier C, representing different picture display modes may be carried above the picture preview area. In addition, as shown in FIG. 10, the display mode identifier currently selected is the mode identifier A, which belongs to the first display mode identifier, representing that each of the at least two to-be-edited pictures added with the target picture effect is currently displayed in the form of the picture set. As shown in FIG. 10, the currently displayed to-be-edited picture added with the target picture effect is the picture A2, and if the user needs to view other to-be-edited pictures added with the target picture effect in the picture set, the user may change the to-be-edited picture displayed in the picture preview area in a left-right sliding manner, for example, switch the picture A2 currently displayed in the picture preview area to the picture B2 in a left sliding manner.

In this embodiment, if the target display mode identifier is the first display mode identifier, the terminal may display the to-be-edited pictures added with the target picture effect in the form of the picture set to improve the diversity of the picture display manners.

In addition, the step S902 may further include: in case that the target display mode identifier is a second display mode identifier, performing picture splicing processing on each of the at least two to-be-edited pictures added with the target picture effect to obtain a spliced picture: and displaying the spliced picture in the picture editing page.

The picture display mode represented by the second display mode identifier is to display each of the at least two to-be-edited pictures added with the target picture effect in the form of the spliced picture. Specifically, if the display mode identifier currently selected by the user is the second display mode identifier, the terminal may perform picture splicing processing on each of the at least two to-be-edited pictures added with the target picture effect to obtain a spliced picture, and then display the spliced picture in the picture editing page.

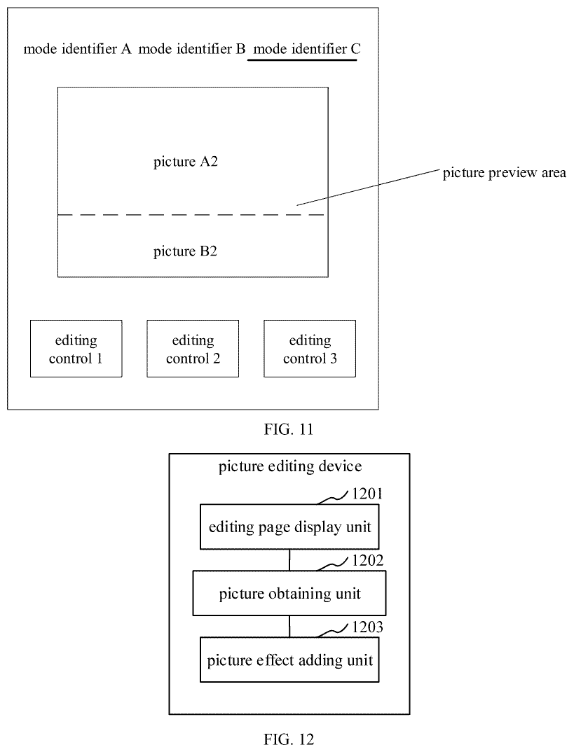

For example, after the target picture effect is added to each of the at least two to-be-edited pictures, and the at least two to-be-edited pictures added with the target picture effect are saved, the displayed picture editing page may be as shown in FIG. 11. This picture editing page may contain the picture preview area, and the editing control 1, the editing control 2 and the editing control 3 for performing picture editing again on the to-be-edited pictures added with the picture effect. Moreover, the plurality of display mode identifiers, such as a mode identifier A, a mode identifier B and a mode identifier C, representing different picture display modes may be carried above the picture preview area. In addition, as shown in FIG. 11, the display mode identifier currently selected is the mode identifier C, which belongs to the second display mode identifier, representing that each of the at least two to-be-edited pictures added with the target picture effect is displayed in the form of the spliced picture. The terminal may perform picture splicing on each of the at least two to-be-edited pictures to form the spliced picture, and display the spliced picture in the picture preview area. Meanwhile, due to the fact that the picture size of the spliced picture exceeds a limitation of the picture preview area, the user may change a picture range of the spliced picture currently displayed in the picture preview area in an up-down sliding manner. For example, as shown in FIG. 11, the picture range of the spliced picture currently displayed in the picture preview area includes a part of the picture A2 and a part of the picture B2, and the user may change the picture range of the spliced picture displayed in the picture preview area through an up-sliding operation to display a part of the picture B2 and a part of the picture B3.

In this embodiment, if the target display mode identifier is the second display mode identifier, the terminal may display the to-be-edited pictures added with the target picture effect in the form of the spliced picture to further improve the diversity of the picture display manners.

In an illustrative embodiment, after the step S902, the method may further include: in response to an identifier switching operation for the display mode identifiers, obtaining a display mode identifier switched to; and displaying each of the at least two to-be-edited pictures added with the target picture effect in the picture editing page according to a picture display mode represented by the display mode identifier.

The identifier switching operation refers to a switching operation for the display mode identifier currently selected. After the user selects the target display mode identifier, the identifier switching operation may be triggered by re-selecting the display mode identifier. The terminal may respond to the identifier switching operation, so as to obtain the display mode identifier switched to, and display the to-be-edited pictures added with the target picture effect in the picture editing page according to the picture display mode represented by the display mode identifier switched to.

For example, the target display mode identifier currently selected may be the first display mode identifier representing displaying in the form of the picture set, and at this moment, the terminal may display each of the at least two to-be-edited pictures added with the target picture effect in the form of the picture set in the picture editing page. If the user re-selects the display mode identifier to trigger the identifier switching operation to switch the first display mode identifier currently selected to such as the second display mode identifier that represents displaying in the form of the spliced picture, the terminal may switch the display mode for the to-be-edited pictures added with the target picture effect in the picture editing page from the form of the picture set to the form of the spliced picture.

In this embodiment, the display mode of each of the at least two to-be-edited pictures added with the target picture effect in the picture editing page may be updated by means of the identifier switching operation, so that the intelligence of displaying the to-be-edited pictures added with the picture effect is further improved.

In an illustrative embodiment, a method for adding an effect template to a plurality of pictures is further provided, which realizes the template editing operation on the plurality of pictures without exiting a template editing panel, and realizes a function of applying a current effect to all the pictures by one click. The method specifically includes steps as follows.
(1) A user selects the plurality of pictures and enters an editing page, clicks a template tool control, and enters a template panel.
(2) Elements in the template panel may include: a picture preview area, thumbnails corresponding to the plurality of pictures selected by the user, an effect template list, and an “application for all” control that applies the effect template to all the pictures.
(3) When the user clicks on a thumbnail area, the picture may be switched, and the picture preview area displays a picture corresponding to the selected thumbnail.
(4) When the user clicks on a certain effect template contained in the effect template list, the picture effect of the effect template may be applied to the picture displayed in the preview area.
(5) When the user clicks the “application for all” control, the picture effect of the currently selected effect template may be applied to all the pictures selected by the user.

Through the above embodiments, the template editing operation is performed on the plurality of pictures without exiting the template editing panel, and the function of applying the current effect to all the pictures by one click is realized, so that the picture editing efficiency is improved.

It should be understood that although the steps in each of the flowcharts of the present disclosure are sequentially displayed as indicated by the arrows, these steps are not necessarily to be performed sequentially in the order indicated by the arrows. Unless explicitly stated otherwise herein, the execution of these steps is not strictly limited in order, and these steps may be performed in other orders. Moreover, at least some of the steps in the figures may include several sub-steps or several stages, these sub-steps or stages are not necessarily to be performed at the same moment, but may be executed at different moments, and these sub-steps or stages are also not necessarily to be performed in sequence, but may be performed in turn or alternately with other steps or at least a part of sub-steps or stages in other steps.

It can be understood that the same/similar parts among embodiments of the above-mentioned method in this specification can refer to each other, each embodiment focuses on the difference from other embodiments, and the relevant parts may be referred to the descriptions of other embodiments of the method.

FIG. 12 is a schematic block diagram showing a picture editing device according to an illustrative embodiment. Referring to FIG. 12, the device includes an editing page display unit 1201, a picture obtaining unit 1202, and a picture effect adding unit 1203.

The editing page display unit 1201 is configured to display thumbnails corresponding to each of at least two to-be-edited pictures in a picture editing page, and display at least one picture effect template, in response to a picture effect adding operation for the at least two to-be-edited pictures.

The picture obtaining unit 1202 is configured to, in response to a selection operation for each of the thumbnails, obtain a first to-be-edited picture corresponding to a first thumbnail selected by the selection operation.

The picture effect adding unit 1203 is configured to, in response to an operation of applying a target picture effect template in the at least one picture effect template to the first to-be-edited picture, add a target picture effect corresponding to the target picture effect template to the first to-be-edited picture, and display the first to-be-edited picture added with the target picture effect in the picture editing page.

In an illustrative embodiment, the editing page display unit 1201 is further configured to: display an effect template adding area which includes an effect template display area and a thumbnail display area in the picture editing page in response to the picture effect adding operation: and display the at least one picture effect template in the effect template display area, and display each of the thumbnails in the thumbnail display area. The picture effect adding unit 1203 is further configured to: take a selected picture effect template as the target picture effect template in response to a picture effect template selection operation triggered in the effect template display area: and add the target picture effect corresponding to the target picture effect template to the first to-be-edited picture, and display the first to-be-edited picture added with the target picture effect in the picture editing page.

In an illustrative embodiment, the picture editing page carries a picture preview area. The picture obtaining unit 1202 is further configured to: display the first to-be-edited picture in the picture preview area, and set a selection state of the first thumbnail to a selected state in the thumbnail display area. The picture effect adding unit 1203 is further configured to display the first to-be-edited picture added with the target picture effect in the picture preview area.

In an illustrative embodiment, the picture editing device further includes: a picture switching unit. The picture switching unit is configured to: obtain a second thumbnail switched to in response to a thumbnail switching operation triggered in the thumbnail display area: and display a second to-be-edited picture corresponding to the second thumbnail in the picture preview area, cancel the selected state of the first thumbnail in the thumbnail display area, and set a selection state of the second thumbnail to a selected state.

In an illustrative embodiment, the picture editing page carries an effect template display control. The editing page display unit 1201 is further configured to display the effect template adding area in the picture editing page in response to a trigger operation for the effect template display control.

In an illustrative embodiment, the thumbnail display area carries an effect template application control. The picture effect adding unit 1203 is further configured to: add a target picture effect corresponding to the target picture effect template to each of the at least two to-be-edited pictures, and display each of the at least two to-be-edited pictures added with the target picture effect in the picture editing page, in response to a trigger operation for the effect template application control.

In an illustrative embodiment, the effect template adding area carries a picture saving control, and the picture editing device further includes: a picture storage unit. The picture storage unit is configured to: save each of the at least two to-be-edited pictures added with the target picture effect, and display each of the at least two to-be-edited pictures added with the target picture effect in the picture preview area carried by the picture editing page, in response to a trigger operation for the picture saving control.

In an illustrative embodiment, the picture editing page carries a plurality of display mode identifiers representing different picture display modes. The picture effect adding unit 1203 is further configured to: obtain a target display mode identifier currently selected: and display each of the at least two to-be-edited pictures added with the target picture effect in the picture editing page according to a picture display mode represented by the target display mode identifier.

In an illustrative embodiment, the picture effect adding unit 1203 is further configured to, in case that the target display mode identifier is a first display mode identifier, generate a picture set according to each of the at least two to-be-edited pictures added with the target picture effect: and display pictures contained in the picture set in the picture editing page.

In an illustrative embodiment, the picture effect adding unit 1203 is further configured to, in case that the target display mode identifier is a second display mode identifier, perform picture splicing processing on each of the at least two to-be-edited pictures added with the target picture effect to obtain a spliced picture: and display the spliced picture in the picture editing page.

In an illustrative embodiment, the picture effect adding unit 1203 is further configured to: obtain a display mode identifier switched to in response to an identifier switching operation for the display mode identifiers: and display each of the at least two to-be-edited pictures added with the target picture effect in the picture editing page according to a picture display mode represented by the display mode identifier.

With respect to the device as described in the above embodiments, the specific manners of the individual modules for performing operations have been described in detail in the embodiments regarding the method, which will not be elaborated herein.

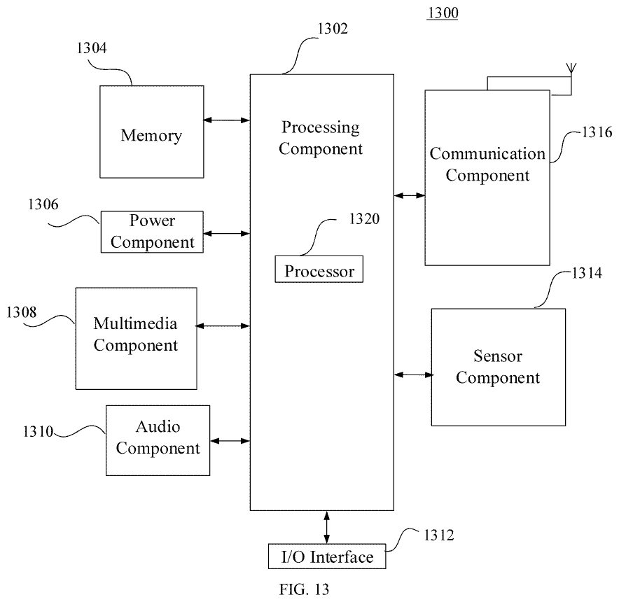

FIG. 13 is a schematic block diagram showing an electronic device 1300 for picture editing according to an illustrative embodiment. For example, the electronic device 1300 may be a mobile phone, a computer, a digital broadcast terminal, a messaging device, a game console, a tablet device, a medical device, a fitness device, a personal digital assistant, or the like.

Referring to FIG. 13, the electronic device 1300 may include one or more of the following components: a processing component 1302, a memory 1304, a power component 1306, a multimedia component 1308, an audio component 1310, an input/output (I/O) interface 1312, a sensor component 1314, and a communication component 1316.

The processing component 1302 typically controls overall operations of the electronic device 1300, such as the operations associated with display, phone calls, data communications, camera operations, and recording operations. The processing component 1302 can include one or more processors 1320 to execute instructions to perform all or some of the steps in the above-described methods. Moreover, the processing component 1302 may include one or more modules which facilitate the interaction between the processing component 1302 and other components. For instance, the processing component 1302 may include a multimedia module to facilitate the interaction between the multimedia component 1308 and the processing component 1302.

The memory 1304 is configured to store various types of data to support the operation of the electronic device 1300. Examples of such data include instructions for any applications or methods operated on the electronic device 1300, contact data, phonebook data, messages, pictures, videos, etc. The memory 1304 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic, an optical disk or a graphene memory.

The power component 1306 provides power to various components of the electronic device 1300. The power component 1306 may include a power management system, one or more power sources, and any other components associated with the generation, management, and distribution of power in the electronic device 1300.

The multimedia component 1308 includes a screen providing an output interface between the electronic device 1300 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1308 includes a front camera and/or a rear camera. The front camera and/or the rear camera may receive an external multimedia datum while the electronic device 1300 is in an operation mode, such as a photographing mode or a video mode. Each of the front camera and the rear camera may be a fixed optical lens system or have focus and optical zoom capability.

The audio component 1310 is configured to output and/or input audio signals. For example, the audio component 1310 includes a microphone (MIC) configured to receive an external audio signal when the electronic device 1300 is in an operation mode, such as a call mode, a recording mode, and a voice recognition mode. The received audio signal may be further stored in the memory 1304 or sent via the communication component 1316. In some embodiments, the audio component 1310 further includes a speaker to output audio signals.

The I/O interface 1312 provides an interface between the processing component 1302 and peripheral interface modules, such as keyboards, click wheels, buttons, and the like. The buttons may include, but are not limited to, a home button, a volume button, a starting button, and a locking button.

The sensor component 1314 includes one or more sensors to provide status assessments of various aspects of the electronic device 1300. For instance, the sensor component 1314 may detect an open/closed status of the electronic device 1300, relative positioning of components, e.g., the display and the keypad, of the electronic device 1300, a change in position of the electronic device 1300 or a component of the electronic device 1300, a presence or absence of user contact with the electronic device 1300, an orientation or an acceleration/deceleration of the electronic device 1300, and a change in temperature of the electronic device 1300. The sensor component 1314 may include a proximity sensor configured to detect the presence of nearby objects without any physical contact. The sensor component 1314 may further include a light sensor, such as a CMOS or CCD image sensor, for use in imaging applications. In some embodiments, the sensor component 1314 may further include an accelerometer sensor, a gyroscope sensor, a magnetic sensor, a pressure sensor, or a temperature sensor.

The communication component 1316 is configured to facilitate communication, wired or wireless, between the electronic device 1300 and other devices. The electronic device 1300 can access a wireless network based on a communication standard, such as WiFi, an operator network (for example, 2G, 3G, 4G or 5G), or a combination thereof. In an illustrative embodiment, the communication component 1316 receives a broadcast signal or broadcast associated information from an external broadcast management system via a broadcast channel. In an illustrative embodiment, the communication component 1316 further includes a near field communication (NFC) module to facilitate short-range communications. For example, the NFC module may be implemented based on a radio frequency identification (RFID) technology, an infrared data association (IrDA) technology, an ultra-wideband (UWB) technology; a Bluetooth (BT) technology, and other technologies.

In an illustrative embodiment, the electronic device 1300 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic elements, for performing the above method.

In an illustrative embodiment, there is also provided a computer readable storage medium including instructions, such as included in the memory 1304, executable by the processor 1320 in the electronic device 1300, for completing the above method. For example, the computer-readable storage medium may be a ROM, a random access memory (RAM), a CD-ROM, a magnetic tape, a floppy disc, an optical data storage device, and the like.

In an illustrative embodiment, a computer program product is further provided. The computer program product includes an instruction, and the instruction may be executed by a processor 1320 of the electronic device 1300 to perform the above method.

It should be noted that the picture editing device, the electronic device, the computer-readable storage medium, and the computer program product as described above may further include other embodiments based on the description of the method embodiments, and the specific implementations may refer to the description of the related method embodiments, which will not be elaborated herein.

Other embodiments of the present disclosure will be apparent to those skilled in the art from consideration of the specification and practice of the present disclosure disclosed here. The present disclosure is intended to cover any variations, uses, or adaptations of the present disclosure following the general principles thereof and including such departures from the present disclosure as come within known or customary practice in the art. It is intended that the specification, embodiments and examples be considered as illustrative only, with a true scope and spirit of the present disclosure being indicated by the claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A picture editing method, comprising:
in response to a picture effect adding operation for at least two to-be-edited pictures, displaying thumbnails corresponding to each of the at least two to-be-edited pictures in a picture editing page, and displaying at least one picture effect template;
in response to a selection operation for each of the thumbnails, obtaining a first to-be-edited picture corresponding to a first thumbnail selected by the selection operation; and
in response to an operation of applying a target picture effect template in the at least one picture effect template to the first to-be-edited picture, adding a target picture effect corresponding to the target picture effect template to the first to-be-edited picture, and displaying the first to-be-edited picture added with the target picture effect in the picture editing page.

2. The method according to claim 1, wherein in response to the picture effect adding operation for at least two to-be-edited pictures, displaying the thumbnails corresponding to each of the at least two to-be-edited pictures in the picture editing page, and displaying the at least one picture effect template comprise:
in response to the picture effect adding operation, displaying an effect template adding area in the picture editing page: wherein the effect template adding area comprises an effect template display area and a thumbnail display area; and
displaying the at least one picture effect template in the effect template display area, and displaying each of the thumbnails in the thumbnail display area;
wherein in response to the operation of applying the target picture effect template in the at least one picture effect template to the first to-be-edited picture, adding the target picture effect corresponding to the target picture effect template to the first to-be-edited picture, and displaying the first to-be-edited picture added with the target picture effect in the picture editing page comprise:
in response to a picture effect template selection operation triggered in the effect template display area, taking a selected picture effect template as the target picture effect template; and
adding the target picture effect corresponding to the target picture effect template to the first to-be-edited picture, and displaying the first to-be-edited picture added with the target picture effect in the picture editing page.

3. The method according to claim 2, wherein the picture editing page carries a picture preview area:
the method further comprises:
displaying the first to-be-edited picture in the picture preview area, and setting a selection state of the first thumbnail to a selected state in the thumbnail display area; and
wherein displaying the first to-be-edited picture added with the target picture effect in the picture editing page comprises:
displaying the first to-be-edited picture added with the target picture effect in the picture preview area.

4. The method according to claim 3, wherein the method further comprises:
in response to a thumbnail switching operation triggered in the thumbnail display area, obtaining a second thumbnail switched to; and
displaying a second to-be-edited picture corresponding to the second thumbnail in the picture preview area, canceling the selected state of the first thumbnail in the thumbnail display area, and setting a selection state of the second thumbnail to a selected state.

5. The method according to claim 2, wherein the picture editing page carries an effect template display control; and in response to the picture effect adding operation, displaying the effect template adding area in the picture editing page comprises:
in response to a trigger operation for the effect template display control, displaying the effect template adding area in the picture editing page.

6. The method according to claim 2, wherein the thumbnail display area carries an effect template application control; and
the method further comprises:
in response to a trigger operation for the effect template application control, adding a target picture effect corresponding to the target picture effect template to each of the at least two to-be-edited pictures, and displaying each of the at least two to-be-edited pictures added with the target picture effect in the picture editing page.

7. The method according to claim 6, wherein the effect template adding area carries a picture saving control; and
displaying each of the at least two to-be-edited pictures added with the target picture effect in the picture editing page comprises:
in response to a trigger operation for the picture saving control, saving each of the at least two to-be-edited pictures added with the target picture effect, and displaying each of the at least two to-be-edited pictures added with the target picture effect in the picture preview area carried by the picture editing page.

8. The method according to claim 6, wherein the picture editing page carries a plurality of display mode identifiers representing different picture display modes; and
displaying each of the at least two to-be-edited pictures added with the target picture effect in the picture editing page comprises:
obtaining a target display mode identifier currently selected; and
displaying each of the at least two to-be-edited pictures added with the target picture effect in the picture editing page according to a picture display mode represented by the target display mode identifier.

9. The method according to claim 8, wherein displaying each of the at least two to-be-edited pictures added with the target picture effect in the picture editing page according to the picture display mode represented by the target display mode identifier comprises:
in case that the target display mode identifier is a first display mode identifier, generating a picture set according to each of the at least two to-be-edited pictures added with the target picture effect; and
displaying pictures contained in the picture set in the picture editing page.

10. The method according to claim 8, wherein displaying each of the at least two to-be-edited pictures added with the target picture effect in the picture editing page according to the picture display mode represented by the target display mode identifier comprises:
in case that the target display mode identifier is a second display mode identifier, performing picture splicing processing on each of the at least two to-be-edited pictures added with the target picture effect to obtain a spliced picture; and
displaying the spliced picture in the picture editing page.

11. The method according to claim 8, wherein after displaying each of the at least two to-be-edited pictures added with the target picture effect in the picture editing page according to the picture display mode represented by the target display mode identifier, the method further comprises:
in response to an identifier switching operation for the display mode identifiers, obtaining a display mode identifier switched to; and
displaying each of the at least two to-be-edited pictures added with the target picture effect in the picture editing page according to a picture display mode represented by the display mode identifier.

12. An electronic device, comprising:
a processor; and
a memory configured to store a processor-executable instruction;
wherein the processor is configured to execute the instruction to:
in response to a picture effect adding operation for at least two to-be-edited pictures, display thumbnails corresponding to each of the at least two to-be-edited pictures in a picture editing page, and display at least one picture effect template;
in response to a selection operation for each of the thumbnails, obtain a first to-be-edited picture corresponding to a first thumbnail selected by the selection operation; and
in response to an operation of applying a target picture effect template in the at least one picture effect template to the first to-be-edited picture, add a target picture effect corresponding to the target picture effect template to the first to-be-edited picture, and display the first to-be-edited picture added with the target picture effect in the picture editing page.

13. The electronic device according to claim 12, wherein the processor is further configured to:
in response to the picture effect adding operation, display an effect template adding area in the picture editing page: wherein the effect template adding area comprises an effect template display area and a thumbnail display area; and
display the at least one picture effect template in the effect template display area, and display each of the thumbnails in the thumbnail display area;
wherein the processor is further configured to:
in response to a picture effect template selection operation triggered in the effect template display area, take a selected picture effect template as the target picture effect template; and
add the target picture effect corresponding to the target picture effect template to the first to-be-edited picture, and display the first to-be-edited picture added with the target picture effect in the picture editing page.

14. The electronic device according to claim 13, wherein the picture editing page carries a picture preview area:
wherein the processor is further configured to: display the first to-be-edited picture in the picture preview area, and set a selection state of the first thumbnail to a selected state in the thumbnail display area; and
wherein the processor is further configured to: display the first to-be-edited picture added with the target picture effect in the picture preview area.

15. The electronic device according to claim 14, wherein the processor is further configured to:
in response to a thumbnail switching operation triggered in the thumbnail display area, obtain a second thumbnail switched to; and
display a second to-be-edited picture corresponding to the second thumbnail in the picture preview area, cancel the selected state of the first thumbnail in the thumbnail display area, and set a selection state of the second thumbnail to a selected state.

16. The electronic device according to claim 13, wherein the picture editing page carries an effect template display control; and
wherein the processor is further configured to: in response to a trigger operation for the effect template display control, display the effect template adding area in the picture editing page.

17. The electronic device according to claim 13, wherein the thumbnail display area carries an effect template application control; and
wherein the processor is further configured to:
in response to a trigger operation for the effect template application control, add a target picture effect corresponding to the target picture effect template to each of the at least two to-be-edited pictures, and display each of the at least two to-be-edited pictures added with the target picture effect in the picture editing page.

18. The electronic device according to claim 17, wherein the effect template adding area carries a picture saving control; and
wherein the processor is further configured to:
in response to a trigger operation for the picture saving control, save each of the at least two to-be-edited pictures added with the target picture effect, and display each of the at least two to-be-edited pictures added with the target picture effect in the picture preview area carried by the picture editing page.

19. The electronic device according to claim 17, wherein the picture editing page carries a plurality of display mode identifiers representing different picture display modes; and
wherein the processor is further configured to:
obtain a target display mode identifier currently selected; and
display each of the at least two to-be-edited pictures added with the target picture effect in the picture editing page according to a picture display mode represented by the target display mode identifier.

20. A non-transitory computer-readable storage medium having stored therein an instruction that, when executed by a processor of an electronic device, causes the electronic device to:
in response to a picture effect adding operation for at least two to-be-edited pictures, display thumbnails corresponding to each of the at least two to-be-edited pictures in a picture editing page, and displaying at least one picture effect template;
in response to a selection operation for each of the thumbnails, obtain a first to-be-edited picture corresponding to a first thumbnail selected by the selection operation; and
in response to an operation of applying a target picture effect template in the at least one picture effect template to the first to-be-edited picture, add a target picture effect corresponding to the target picture effect template to the first to-be-edited picture, and display the first to-be-edited picture added with the target picture effect in the picture editing page.
